(19) United States
(12) Patent Application Publication
(10) Pub. No.: US 2009/0044175 A1
(43) Pub. Date: Feb. 12, 2009

(54) REAL-TIME WATCH DEVICE AND METHOD

(76) Inventor: Masahiro Sekiguchi, Kyoto (JP)

Correspondence Address: MCDERMOTT WILL & EMERY LLP, 600 13TH STREET, NW, WASHINGTON, DC, 20005-3096, US

(21) Appl. No.: 12/188,650

(22) Filed: Aug. 8, 2008

(30) Foreign Application Priority Data
Aug. 8, 2007 (JP) 2007-206433

(51) Int. Cl. G06F 9/44

(52) U.S. Cl. 717/127

(57) ABSTRACT

The real-time watch device for displaying a value in a memory used by a target system during execution of a program in the target system, includes: a watch information acquisition section for acquiring registered watch information; a memory access section for reading a value stored at a received memory address from the memory; a memory accessibility determination section for determining whether or not a memory address to be referred to given in the acquired watch information is accessible; and a watch display section for outputting a memory address determined accessible by the memory accessibility determination section to the memory access section and displaying a value read by the memory access section.

### CROSS-REFERENCE TO RELATED APPLICATIONS

This application claims priority under 35 U.S.C. §119 on Patent Application No. 2007-206433 filed in Japan on Aug. 8, 2007, the entire contents of which are hereby incorporated by reference.

### BACKGROUND OF THE INVENTION

The present invention relates to a debugging technology in development of software for embedded equipment.

In development of embedded equipment, an emulator is used in some cases. At the initial stage of the development, emulation memory mounted on an emulator is used. At the end of the development, however, even in the case of using an emulator, debugging must be made using a built-in memory internal to a microcontroller of the actual embedded equipment and an expanded memory external to the microcontroller. In general, an emulator has a function of accessing memories such as those internal and external to a microcontroller. At debugging of a user program, the emulator is allowed to refer to and change the contents of various memories while permitting the microcontroller to execute or stop the program.

The access function of the emulator to various memories is realized, for example, by forcing the microcontroller to stop execution of a user program and instead execute an emulator control program (monitor program) to allow the contents of the memories to be outputted externally. Alternatively, for minimizing the impact from stopping the user program and others, proposed is a method of referring to an external memory via a direct memory access controller (DMAC) for debugging incorporated in a microcontroller (see Japanese Laid-Open Patent Publication No. 8-328898). In this method, in which the memory bus use right is granted from the CPU of the microcontroller to secure access to the memory, the impact on execution of the user program is smaller compared with the method of referring to memories using a monitor program described above.

At debugging in program development, a real-time watch device is used, which periodically accesses various memories to refer to values during execution of a program using the above memory access technology.

Recently, needs for multi-function, high-performance embedded equipment have been grown. In step with this, software for controlling embedded equipment has become increasingly enormous. Even in a field where 8-bit microcontrollers were conventionally the mainstream, a shift to 32-bit microcontrollers wider in memory space is underway. Moreover, an increasing number of systems have an external memory in addition to a memory incorporated in a microcontroller. When a program operating with the CPU of a microcontroller uses an external memory, initial setting must be made for the bus width, the wait, start/end timing of the bus cycle and the like with a control register such as a memory control register.

Normally, the above setting is made in a startup routine of a program. After the setting, safe and correct access to an external memory can be made under the program to permit reference to values. In the case of accessing a memory with a real-time watch function and the like at debugging of a program, also, as in the case of referring to values under a program, safe and correct access will be basically unavailable unless the initial setting has been made. Access to an external memory will be unavailable, either, if the system is reset after the initial setting, in which all the contents of the control register set in the startup routine will be cleared (initialized).

At which timing the system is reset during execution of a program is normally unknown. If the system is reset at the timing when a real-time watch device is periodically referring to an external memory, the real-time watch device fails to perform correct memory reference and this may result in acquiring a wrong memory value. In the worst case, the real-time watch device may fail to perform memory access and stop the program judging that the system has fallen into a critical situation.

Some real-time watch devices have a function of storing watch information indicating a memory address to be referred to, in which at the next startup, the last-registered watch information resumes its registered state. In this relation, if the watch information includes information indicating that an external memory should be referred to, the real-time watch device may fail to correctly refer to the external memory, or may stop the program judging that the system has fallen into a critical state, after start of debugging of the program. The debugging work will therefore be obstructed.

### SUMMARY OF THE INVENTION

An object of the present invention is securing safe and correct reference to a value in a memory used by a target system such as a microcontroller during execution of a program in the target system.

Specifically, the real-time watch device of the present invention is a real-time watch device for displaying a value in a memory used by a target system during execution of a program in the target system, including: a watch information registration section for registering watch information including a memory address to be referred to; a watch information acquisition section for acquiring the registered watch information; a memory access section for reading a value stored at a received memory address from the memory; a memory accessibility determination section for determining whether or not the memory address to be referred to given in the acquired watch information is accessible; and a watch display section for outputting a memory address determined accessible by the memory accessibility determination section to the memory access section and displaying a value read by the memory access section.

In the inventive real-time watch device, in which a value in a memory is actually read and displayed only when the memory address is determined accessible, it is possible to prohibit access to an inaccessible region. Occurrence of an error can therefore be avoided.

According to the present invention, a value in a memory used by a target system can be acquired without occurrence of a critical error during execution of a program in the target system. Safe and correct debugging work can therefore be performed.

### BRIEF DESCRIPTION OF THE DRAWINGS

FIG. 1 is a block diagram of a real-time watch device of Embodiment 1 of the present invention.

FIG. 2 is a view illustrating an example of watch information table.

FIG. 3 is a view illustrating an example of system information table.

FIG. 4 is a flowchart showing a flow of processing in the real-time watch device of FIG. 1.

FIG. 5 is a view illustrating an example of watch display by the real-time watch device of FIG. 1.

FIG. 6 is a block diagram of a real-time watch device of Embodiment 2 of the present invention.

FIG. 7 is a flowchart showing a flow of watch information registration processing in the real-time watch device of FIG. 6.

FIG. 8 is a view illustrating an example of watch information table obtained as a result of the watch information registration processing of FIG. 7.

FIG. 9 is a flowchart showing a flow of watch display processing in the real-time watch device of FIG. 6.

FIG. 10 is a block diagram of a real-time watch device of Embodiment 3 of the present invention.

FIG. 11 is a flowchart showing a flow of watch information updating processing in the real-time watch device of FIG. 10.

### DESCRIPTION OF THE PREFERRED EMBODIMENTS

Hereinafter, preferred embodiments of the present invention will be described with reference to the accompanying drawings.

### Embodiment 1

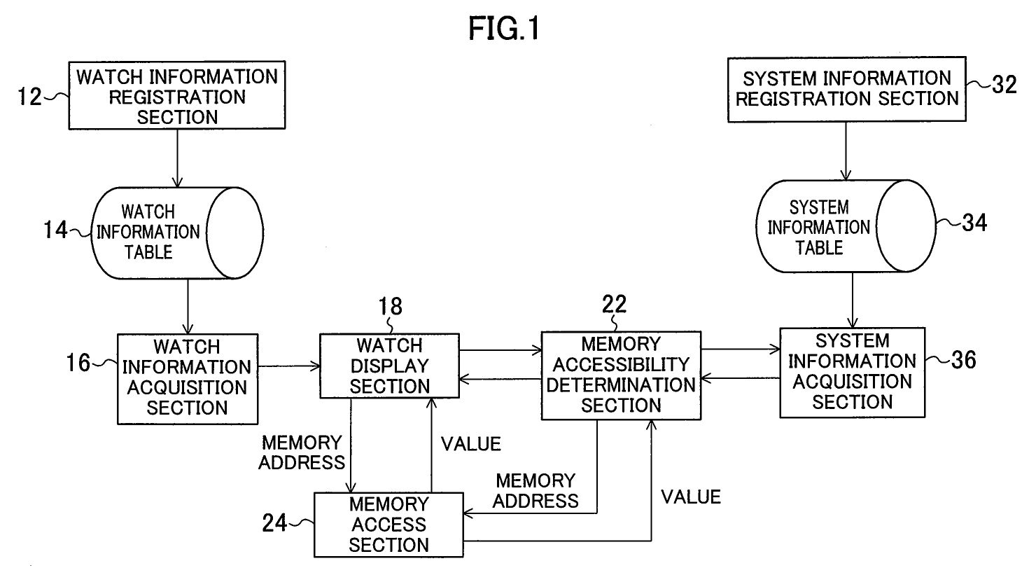

FIG. 1 is a block diagram of a real-time watch device of Embodiment 1 of the present invention. The real-time watch device of FIG. 1 includes a watch information registration section 12, a watch information acquisition section 16, a watch display section 18, a memory accessibility determination section 22, a memory access section 24, a system information registration section 32 and a system information acquisition section 36. During execution of a software program in a target system having a microcontroller and the like, the real-time watch device displays a value in a memory used by the target system.

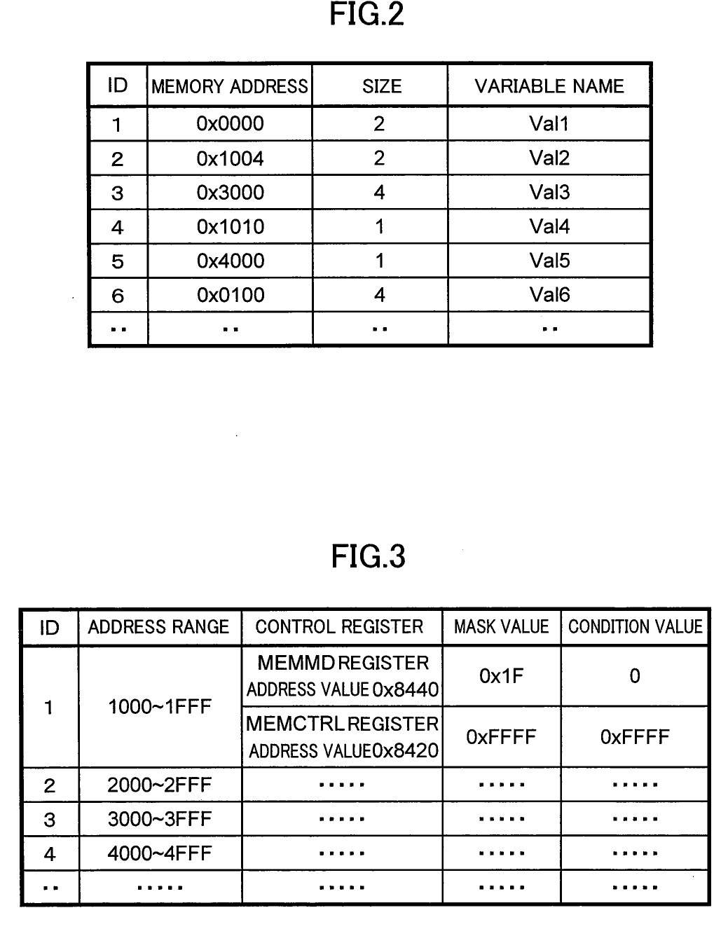

FIG. 2 is a view illustrating an example of a watch information table 14. In the watch information table 14, registered are watch information units respectively identified with watch information IDs. Each watch information unit includes a memory address to be referred to in a memory used by the target system, the size of the value to be referred to, and the name of the variable or symbol stored in the memory address. The watch information is used for the purpose of periodical reference to values in the memory used by the target system.

The watch information registration section 12 registers watch information received via a user interface of the real-time watch device and the like in the watch information table 14 that is stored in a memory section (not shown).

FIG. 3 is a view illustrating an example of a system information table 34. In the system information table 34, registered are system information units respectively identified with system information IDs. Each system information unit includes an address range in a memory such as an external memory expanded by the target system, a memory address used as a control register that requires initial setting for use of the above memory (hereinafter, referred to as a control register address), the mask value for specifying a bit among the bits of the control register that requires initial setting, and the condition value to be stored in the control register address. The combination of the control register address, the mask value and the condition value represents an accessibility condition. If the result of OR computation between the value stored in the control register address and the mask value executed bit by bit agrees with the condition value, the accessibility condition is satisfied.

The system information registration section 32 registers system information received via a user interface of the real-time watch device and the like in the system information table 34 that is stored in the memory section. By registering appropriate system information, it is possible to respond to any change in the target system and the program to be executed.

When receiving a request for registration of system information, the system information registration section 32 may set the accessibility condition of the system information so that the memory value at this time satisfies the accessibility condition of the system information. In other words, the system information registration section 32 may execute OR computation between the memory value stored at this time in the control register address of the system information and the mask value bit by bit and register the result as the condition value of the system information.

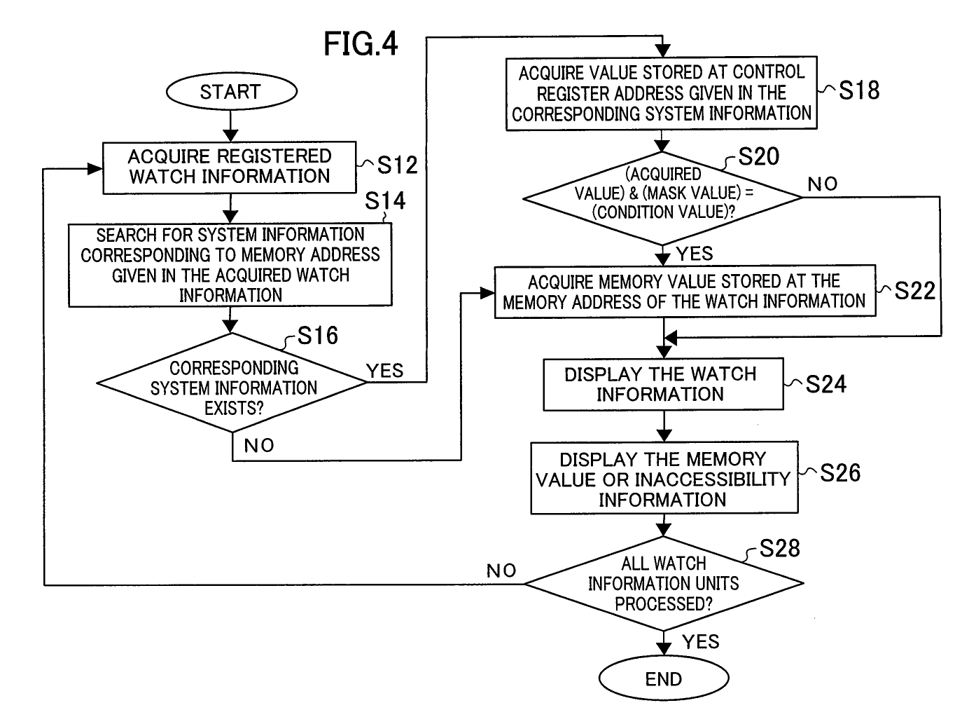

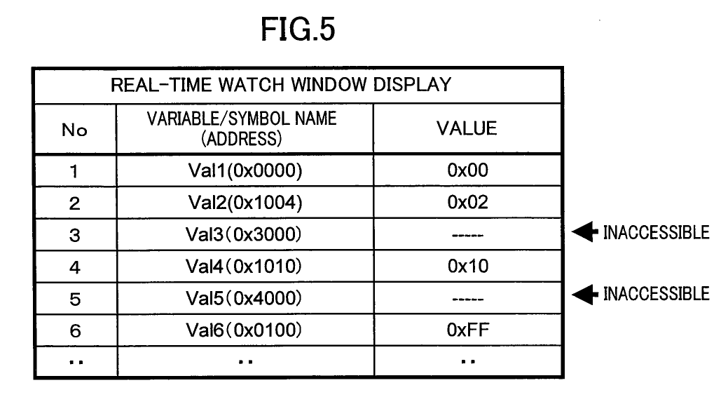

FIG. 4 is a flowchart showing a flow of processing in the real-time watch device of FIG. 1. An example of operation of the real-time watch device of FIG. 1 will be described with reference to FIGS. 1 to 4. Assume that the watch information table 14 is in the state shown in FIG. 2 and the system information table 34 is in the state shown in FIG. 3.

In step S12, once receiving a real-time watch request, the watch information acquisition section 16 first acquires watch information to be processed from the watch information table 14. The watch display section 18 receives the watch information from the watch information acquisition section 16 and outputs the received watch information to the memory accessibility determination section 22.

In step S14, the memory accessibility determination section 22 searches for system information corresponding to the memory address given in the received watch information (system information having an address range within which the memory address given in the watch information exists). In this relation, the system information acquisition section 36 acquires system information from the system information table 34 and outputs the acquired system information to the memory accessibility determination section 22.

For example, for the watch information having an ID of “2” in the watch information table of FIG. 2, in which the registered memory address is 0x1004, the corresponding system information in the system information table of FIG. 3 is one having an ID of “1” whose address range is 0x1000 to 0x1FFF. Likewise, for the watch information having an ID of “3”, in which the registered memory address is 0x3000, the corresponding system information is one having an ID of “3” whose address range is 0x3000 to 0x3FFF. Hence, since different system information units are used for different address ranges, whether to allow access or not can be determined appropriately even when a plurality of memories different in accessibility condition are used.

In step S16, the memory accessibility determination section 22 determines whether or not corresponding system information exists. If corresponding system information exists, the process proceeds to step S18. Otherwise, the process proceeds to step S22. For example, for the watch information having an ID of “1” whose memory address is 0x0000, there is no corresponding system information registered in the system information table of FIG. 3. In such a case, the memory accessibility determination section 22 determines that the memory address of the watch information is accessible at any time, and the process proceeds to the step S22 skipping the determination processing on whether to allow access or not.

In the step S18, the memory accessibility determination section 22 acquires the value stored at the control register address given in the corresponding system information from the memory via the memory access section 24. In step S20, the memory accessibility determination section 22 judges whether or not the accessibility condition is satisfied. More specifically, the memory accessibility determination section 22 computes OR between the acquired value and the mask value of the corresponding system information bit by bit, and judges whether or not the computation result agrees with the condition value of the corresponding system information. Like the system information having an ID of “1” in FIG. 3, system information may include a plurality of combinations of the control register addresses, the mask values and the condition values. In this case, judgment should be made for all the combinations.

If all the judgments on the system information are “agreeing”, the memory accessibility determination section 22 determines that the memory address of the watch information is accessible. The process then proceeds to the step S22. If all the judgments on the system information are not “agreeing”, the memory accessibility determination section 22 determines that the memory address of the watch information is inaccessible, and the process proceeds to step S24. In the step S20, the memory accessibility determination section 22 outputs the determination result to the watch display section 18.

In the step S22, the watch display section 18 outputs the memory address and the size given in the watch information to be processed to the memory access section 24. The memory access section 24 reads the value having the received size stored at the received memory address from the memory used by the target system, and outputs the read value to the watch display section 18.

In the step S24, the watch display section 18 displays the memory address and the variable name given in the watch information to be processed. In step S26, the watch display section 18 displays the value received from the memory access section 24 if the memory address is accessible, or information indicating inaccessibility if the memory address is inaccessible, in association with the variable name.

In step S28, the watch display section 18 determines whether or not the processing has been finished for all the watch information units registered in the watch information table 14. If finished, the processing of FIG. 4 is terminated. If not finished, the process returns to the step S12, to perform processing for the next watch information. The watch information is processed in order of registration.

The real-time watch device of FIG. 1 repeats the processing of FIG. 4 once a program is executed in the target system, to perform real-time watch display every fixed time interval.

FIG. 5 is a view illustrating an example of watch display by the real-time watch device of FIG. 1. In FIG. 5, shown for each row are the watch information ID, the variable/symbol name together with its address and the read memory value. The mark “ - - - ” in the “value” column represents that no memory access is allowed for the variable/symbol concerned.

In the illustrated example, the watch display indicates that no memory access is allowed for the ID “3” (variable Val3, memory address 0x3000) and the ID “5” (variable Val5, memory address 0x4000). From this it is found that memory access has been determined impossible in the address ranges (0x3000 to 0x3FFF and 0x4000 to 0x4FFF) defined in the system information having an ID of “3” (address range 0x3000 to 0x3FFF) and the system information having an ID of “4” (address range 0x4000 to 0x4FFF).

In the above description, when a memory address was determined inaccessible, no lo memory access was made and no real-time watch display was made. Alternatively, a memory value may be changed so as to satisfy the accessibility condition of the system information used for the determination, to permit real-time watch display at any time. For example, the real-time watch device of FIG. 1 may further include a system state change section, which changes the value stored at the control register address of the system information corresponding to the memory address determined inaccessible to be equal to the condition value of the system information concerned, to thereby put the memory address in a memory accessible state.

Also, in the above description, display was made for any watch information irrespective of the result of determination on whether or not the memory address given in the watch information was accessible. Alternatively, display may not be made for watch information determined inaccessible.

In the illustrated example, if watch information was determined inaccessible, display was made to show only the determination result. The way of display is not limited to this. For example, the accessibility condition used for the determination, the current memory value corresponding to the condition value and the like may further be displayed.

In the above description, any address that had not been registered in the system information table (FIG. 3) was determined accessible. Alternatively, considering the possibility of omission in registration of system information, any address that has not been registered in the system information table may be determined inaccessible to ensure that no memory access error occurs in the event of omission in registration.

Thus, in the real-time watch device of this embodiment, access is actually made only to a variable located at an accessible memory address among variables registered as watch information. It is therefore possible to register watch information with no concern for the memory state. Also, in watch display, it is possible to avoid situations that may damage debugging, such as occurrence of a critical memory access error before initial setting and acquisition of a wrong memory value.

### Embodiment 2

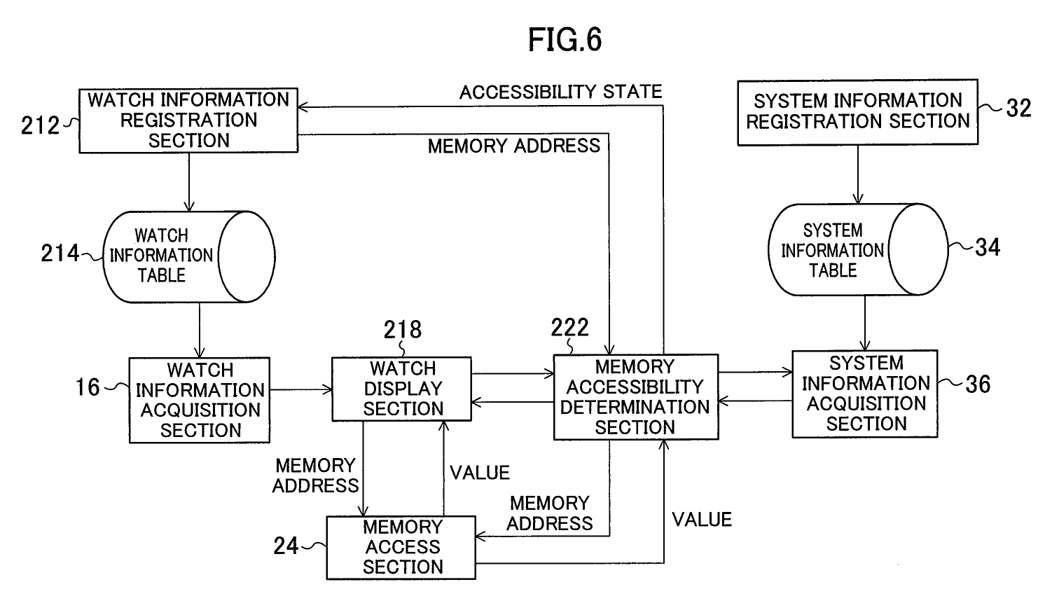

FIG. 6 is a block diagram of a real-time watch device of Embodiment 2 of the present invention. The real-time watch device of FIG. 6 is different from the real-time watch device of FIG. 1 in having a watch information registration section 212, a watch display section 218 and a memory accessibility determination section 222 in place of the watch information registration section 12, the watch display section 18 and the memory accessibility determination section 22.

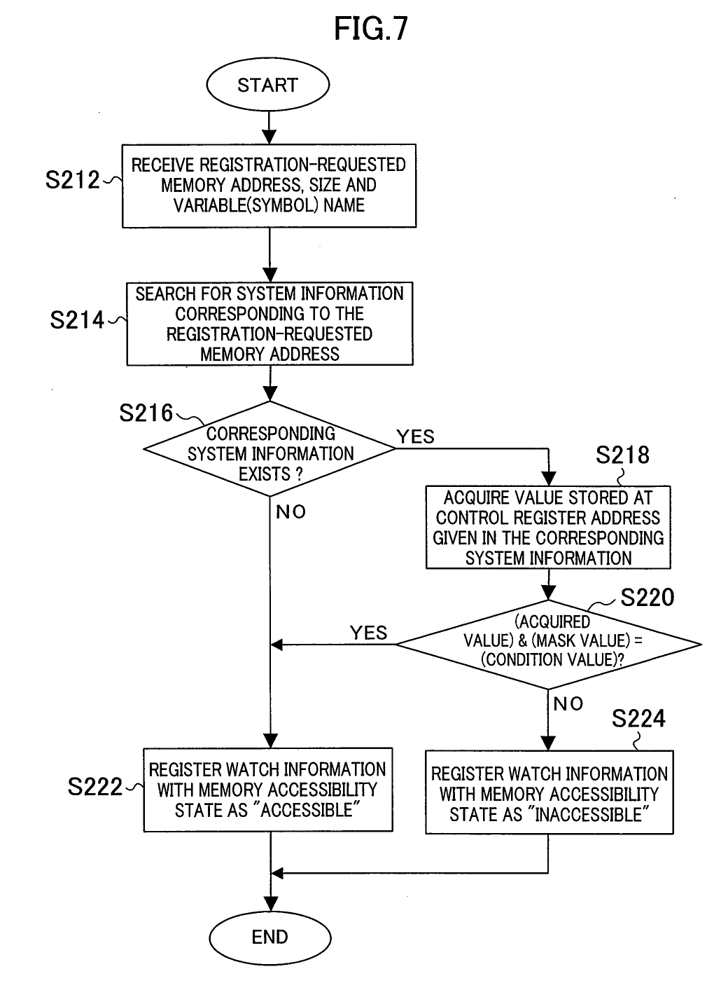

FIG. 7 is a flowchart showing a flow of watch information registration processing in the real-time watch device of FIG. 6. An example of watch information registration processing in the real-time watch device of FIG. 6 will be described with reference to FIGS. 3, 6 and 7. Assume that the system information table 34 is in the state shown in FIG. 3.

In step S212, the watch information registration section 212 receives a watch information registration request via a user interface and the like. The registration request includes the memory address, the size and the variable (symbol) name. In step S214, the memory accessibility determination section 222 searches for system information corresponding to the registration-requested memory address among the system information units registered in the system information table 34. For example, when the registration-requested memory address is 0x1004, the corresponding system information in the system information table of FIG. 3 is one having an ID of “1” whose address range is 0x1000 to 0x1FFF.

In step S216, the memory accessibility determination section 222 determines whether or not corresponding system information exists. If corresponding system information exists, the process proceeds to step S218. Otherwise, the process proceeds to step S222. If no corresponding system information is registered in the system information table 34, the memory accessibility determination section 222 determines that the registration-requested memory address is accessible at any time. The process therefore proceeds to the step S222 skipping the determination processing on whether to allow access or not.

In step S218, the memory accessibility determination section 222 acquires the value stored at the control register address given in the corresponding system information from the memory via the memory access section 24.

In step S220, the memory accessibility determination section 222 computes OR between the acquired value and the mask value of the corresponding system information bit by bit, and judges whether or not the result agrees with the condition value of the corresponding system information.

If all the judgments on the system information are “agreeing”, the memory accessibility determination section 222 determines that the memory address of the watch information is accessible. The process then proceeds to the step S222. If all the judgments on the system information are not “agreeing”, the memory accessibility determination section 222 determines that the memory address of the watch information is inaccessible, and the process proceeds to step S224. The memory accessibility determination section 222 outputs the accessibility state to the watch information registration section 212 as the determination result.

In the step S222, the watch information registration section 212 adds the accessibility state (“accessible”) and the corresponding system information ID to the registration-requested memory address, size and variable (symbol) name, to be registered as watch information. In the step S224, the watch information registration section 212 adds the accessibility state (“inaccessible”) and the corresponding system information ID to the registration-requested memory address, size and variable (symbol) name, to be registered as watch information.

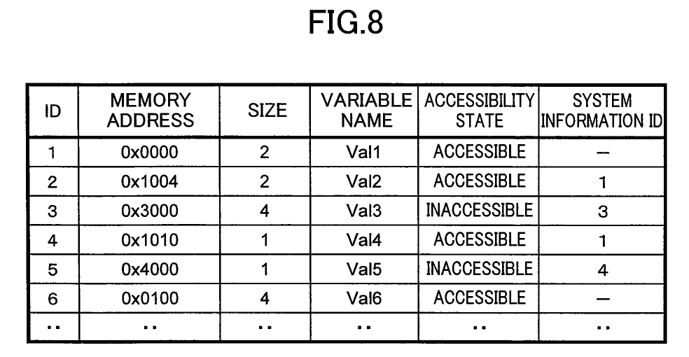

FIG. 8 is a view illustrating an example of a watch information table 214 obtained as a result of the watch information registration processing of FIG. 7. The watch information table 214 is stored in a memory section (not shown).

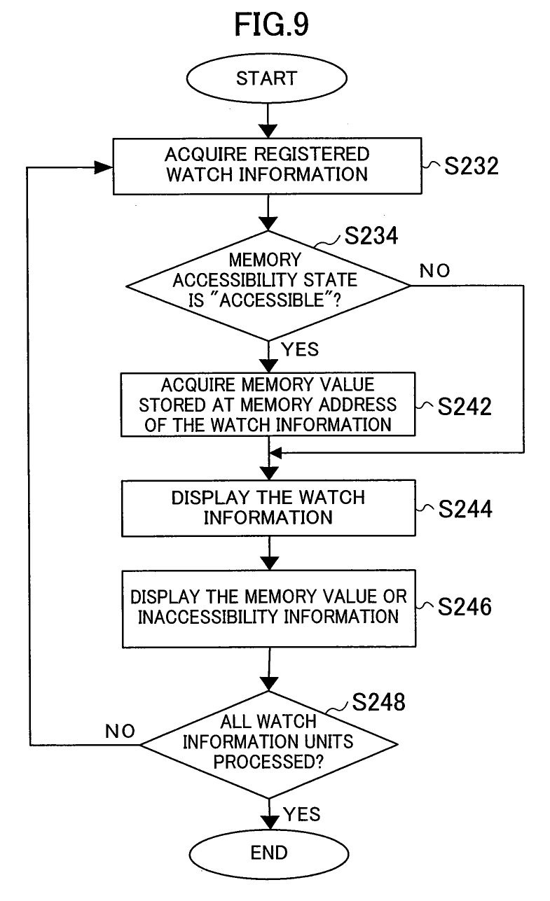

FIG. 9 is a flowchart showing a flow of watch display processing in the real-time watch device of FIG. 6. An example of watch display processing in the real-time watch device of FIG. 6 will be described with reference to FIGS. 3, 6, 8 and 9. Assume that the watch information table 214 is in the state shown in FIG. 8.

In step S232, once receiving a real-time watch request, the watch information acquisition section 16 first acquires watch information to be processed from the watch information table 214 (FIG. 8). The watch display section 218 receives the watch information from the watch information acquisition section 16 and outputs the received watch information to the memory accessibility determination section 222.

In step S234, the memory accessibility determination section 222 determines whether or not the accessibility state given in the acquired watch information is “accessible”. If the state is “accessible”, the process proceeds to step S242. Otherwise, the process proceeds to step S244.

In the step S242, the watch display section 218 outputs the memory address and the size given in the watch information to be processed to the memory access section 24. The memory access section 24 reads the value having the received size stored at the received memory address from the memory used by the target system, and outputs the read value to the watch display section 218.

In the step S244, the watch display section 218 displays the memory address and the variable name given in the watch information to be processed. In step S246, the watch display section 218 displays the value received from the memory access section 24 if the memory address is accessible, or information indicating inaccessibility if the memory address is inaccessible, in association with the variable name.

In step S248, the watch display section 218 determines whether or not processing on all the watch information units registered in the watch information table 214 has been finished. If finished, the processing of FIG. 9 is terminated. If not finished, the process returns to the step S232, to perform processing for the next watch information. The watch information is processed in order of registration.

The real-time watch device of FIG. 6 repeats the processing of FIG. 9 once a program is executed in the target system, to perform real-time watch display every fixed time interval.

Thus, in the real-time watch device of FIG. 6, memory accessibility is determined at the time of registration of watch information, and the result is added to the watch information as the accessibility state. This simplifies the processing of determining the accessibility to a memory used by the target system at the time of real-time watch display, and thus the watch display processing can be sped up.

### Embodiment 3

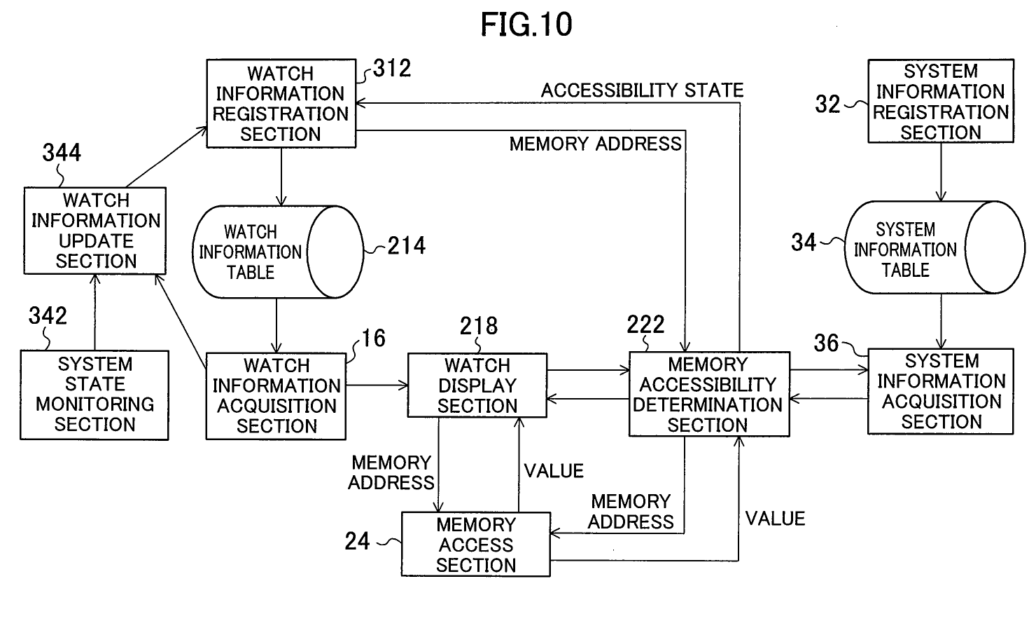

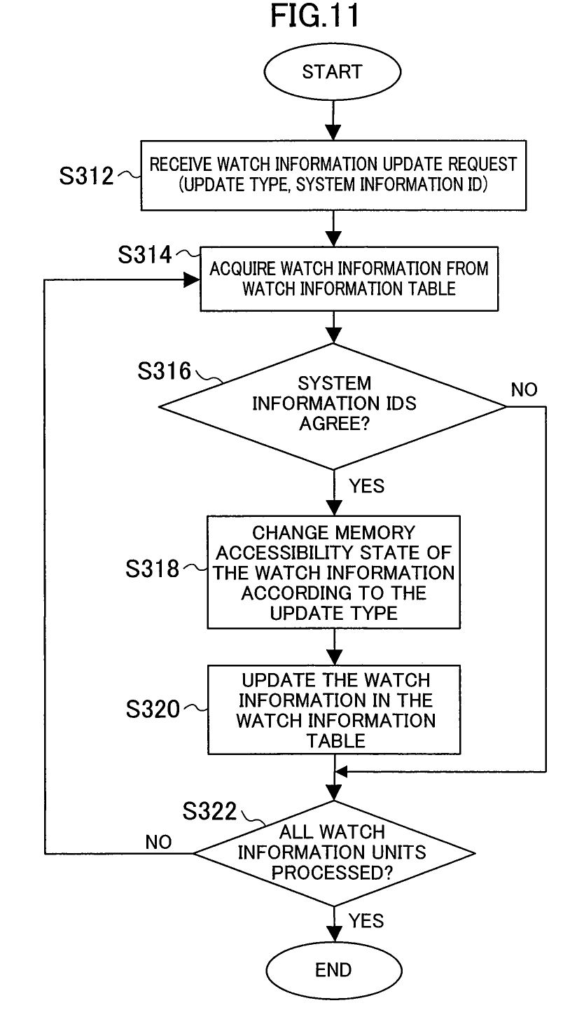

FIG. 10 is a block diagram of a real-time watch device of Embodiment 3 of the present invention. The real-time watch device of FIG. 10 is different from the real-time watch device of FIG. 6 in having a watch information registration section 312 in place of the watch information registration section 212 and newly having a system state monitoring section 342 and a watch information update section 344.

The system state monitoring section 342 monitors the state of the target system to be subjected to debugging and real-time watch, and once detecting a predetermined state, issues an update request to the watch information update section 344 asking for update of the watch information table. The watch information update section 344 updates the memory accessibility state given in the watch information in response to the update request.

Examples of the state of the target system to be detected include resetting (initialization) of the target system, start of execution of a microcontroller program (shift to a microcontroller user mode), stop of a microcontroller program (shift to a microcontroller monitor mode), execution of a specific program code (execution of a command at a specific address) and access to a specific memory.

When detecting resetting to the microcontroller, for example, the system state monitoring section 342 issues an update request to the watch information update section 344 asking for making the accessibility state “inaccessible” for watch information corresponding to all system information IDs. Also, when execution of a command at a specific address is detected, for example, it can be judged that initial setting for an external memory has been completed in a specific system information ID. The system state monitoring section 342 therefore issues an update request to the watch information update section 344 asking for making the accessibility state “accessible” for watch information corresponding to the specific system information ID.

An update request can also be issued in any situation other than those described above as long as there is the possibility of occurrence of a change in the memory accessibility state and such a change is detectable.

FIG. 11 is a flowchart showing a flow of watch information update processing in the real-time watch device of FIG. 10. An example of watch information update processing in the real-time watch device of FIG. 10 will be described with reference to FIGS. 8, 10 and 11. Assume that the watch information table 214 is in the state shown in FIG. 8.

In step S312, the watch information update section 344 receives an update request for watch information from the system state monitoring section 342. The update request includes the system information ID corresponding to the object to be updated and the update type indicating to which state, “accessible” or “inaccessible”, the accessibility state should be changed. In step S314, the watch information update section 344 acquires watch information from the watch information table 214.

In step S316, the watch information update section 344 determines whether or not the system information ID given in the watch information agrees with the system information ID related to the update request. If the system information ID agrees, the process proceeds to step S318. Otherwise, the process proceeds to step S322.

In the step S318, the watch information update section 344 changes the memory accessibility state of the acquired watch information according to the update type and outputs the result to the watch information registration section 312. In step S320, the watch information registration section 312 updates the watch information in the watch information table 214 with the changed watch information. Except for this point, the watch information registration section 312 is the same as the watch information registration section 212.

In the step S322, the watch information update section 344 determines whether or not the processing has been finished for all the watch information units registered in the watch information table. If finished, the processing of FIG. 11 is terminated. Otherwise, the process returns to the step S314 to perform processing for the next watch information.

In the above description, the system state monitoring section 342 notified the watch information update section 344 of the system information ID to be updated and the update type. Alternatively, the system state monitoring section 342 may only issue an update request. In this case, the watch information update section 344 checks the current state of the target system through the system information table 34, to change the watch information if required and update the watch information table 214.

Thus, in the real-time watch device of FIG. 10, the accessibility state given in the watch information, which influences whether or not to actually access the memory, is updated as necessary in accordance with a change in the state of the target system. Hence, the state of the target system can be referred to by a larger number of watch information units while safety and correctness being maintained.

As described above, the present invention, which provides safe reference to memory values, is useful for a real-time watch device for debugging of a system using a memory and the like.

While the present invention has been described in preferred embodiments, it will be apparent to those skilled in the art that the disclosed invention may be modified in numerous ways and may assume many embodiments other than those specifically set out and described above. Accordingly, it is intended by the appended claims to cover all modifications of the invention which fall within the true spirit and scope of the invention.

What is claimed is:

1. A real-time watch device for displaying a value in a memory used by a target system during execution of a program in the target system, comprising:
a watch information registration section for registering watch information including a memory address to be referred to;
a watch information acquisition section for acquiring the registered watch information;
a memory access section for reading a value stored at a received memory address from the memory;
a memory accessibility determination section for determining whether or not the memory address to be referred to given in the acquired watch information is accessible; and
a watch display section for outputting a memory address determined accessible by the memory accessibility determination section to the memory access section and displaying a value read by the memory access section.

2. The device of claim 1, further comprising a system information acquisition section for acquiring system information including a memory address range and a corresponding accessibility condition,
wherein the memory accessibility determination section determines whether or not the memory address to be referred to given in the acquired watch information is accessible according to the system information corresponding to the memory address.

3. The device of claim 2, further comprising a system information registration section for registering system information including a memory address range and a corresponding accessibility condition.

4. The device of claim 3, wherein when receiving a request for registering system information, the system information registration section sets the accessibility condition of the registration-requested system information so that the memory value at this time satisfies the accessibility condition of the registration-requested system information.

5. The device of claim 2, wherein the watch information registration section registers the result of determination on whether or not a memory address registration-requested as the memory address to be referred to is accessible in the watch information as a memory accessibility state in association with the registration-requested memory address, the determination being made based on the system information corresponding to the registration-requested memory address, and
the memory accessibility determination section determines whether or not the memory address is accessible according to the registered memory accessibility state.

6. The device of claim 5, further comprising:
a system state monitoring section for detecting the state of the target system and issuing an update request according to the detected state; and
a watch information update section for updating the memory accessibility state given in the watch information in response to the update request.

7. The device of claim 6, wherein the system state monitoring section detects initialization of the target system.

8. The device of claim 6, wherein the system state monitoring section detects stop of execution of a program operating in the target system.

9. The device of claim 6, wherein the system state monitoring section detects start of execution of a program in the target system.

10. The device of claim 6, wherein the system state monitoring section detects execution of a specific code by the target system.

11. The device of claim 6, wherein the system state monitoring section detects access to a specific memory by the target system.

12. The device of claim 2, wherein the watch display section displays the accessibility condition given in the acquired system information and the state of the target system related to the accessibility condition, together with watch information determined inaccessible by the memory accessibility determination section and information indicating the inaccessibility.

13. The device of claim 2, further comprising:
a system state change section for changing the memory value when the memory address is determined inaccessible by the memory accessibility determination section, the change being made so as to satisfy the accessibility condition of system information used for the determination.

14. The device of claim 1, wherein the watch display section displays watch information determined inaccessible by the memory accessibility determination section together with information indicating the inaccessibility.

15. A real-time watch method for displaying a value in a memory used by a target system during execution of a program in the target system, comprising the steps of:
a) acquiring registered watch information including a memory address to be referred to in the memory;
b) determining whether or not the memory address to be referred to given in the acquired watch information is accessible; and
c) displaying a value stored at a memory address determined accessible in the step b).

16. The method of claim 15, further comprising the step of: d) acquiring system information including a memory address range and a corresponding accessibility condition,
wherein the step b) includes determining whether or not the memory address to be referred to given in the acquired watch information is accessible according to the system information corresponding to the memory address.

17. The method of claim 16, further comprising the step of: e) registering system information including a memory address range and a corresponding accessibility condition.

18. The method of claim 16, further comprising the step of: f) registering the result of determination on whether or not a memory address registration-requested as the memory address to be referred to is accessible in the watch information as a memory accessibility state in association with the registration-requested memory address, the determination being made based on the system information corresponding to the registration-requested memory address, and
the step b) includes determining whether or not the memory address is accessible according to the registered memory accessibility state.

19. The method of claim 18, further comprising the steps of:
g) detecting the state of the target system and issuing an update request according to the detected state; and
h) updating the memory accessibility state given in the watch information in response to the update request.

20. The method of claim 19, wherein the step g) includes detecting initialization of the target system.

21. The method of claim 19, wherein the step g) includes detecting stop of execution of a program operating in the target system.

22. The method of claim 19, wherein the step g) includes detecting start of execution of a program in the target system.

23. The method of claim 19, wherein the step g) includes detecting execution of a specific code by the target system.

24. The method of claim 19, wherein the step g) includes detecting access to a specific memory by the target system.

25. The method of claim 16, wherein the step c) includes displaying the accessibility condition given in the acquired system information and the state of the target system related to the accessibility condition, together with watch information determined inaccessible in the step b) and information indicating the inaccessibility.

26. The method of claim 16, further comprising the step of:
changing the memory value when the memory address is determined inaccessible in the step b), the change being made so as to satisfy the accessibility condition of system information used for the determination.

27. The method of claim 15, wherein the step c) includes displaying watch information determined inaccessible in the step b) together with information indicating the inaccessibility.
